(19) United States
(12) Patent Application Publication
(10) Pub. No.: US 2007/0144260 A1
(43) Pub. Date: Jun. 28, 2007

(54) Non-destructive evaluation of particulate filters

(76) Inventors: Dong Fei, Peoria, IL (US); Craig F. Habeger, Chillicothe, IL (US); Kent A. Koshkarian, Peoria, IL (US); Douglas A. Rebinsky, Peoria, IL (US); Cheryl L. Sellers, Peoria, IL (US); Todd M. Swanson, Alpha, IL (US); Leonard G. Wheat, Manito, IL (US); Benjamin J. Wyss, Goodfield, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/319,025

(22) Filed: Dec. 27, 2005

(51) Int. Cl. G01N 9/04

(52) U.S. Cl. 73/596

(57) ABSTRACT

A filter internal flaw test apparatus includes a frame with a filter support and at least one pair of transducer supports. A filter is positioned in the test apparatus, and an ultrasound through transmission test and at least one ultrasound pulse echo test are performed on the filter. Data reliability is increased by positioning the pair of transducers in alignment with one another and pushing them toward one another using a force generator with a predetermined uniform force, such as via a regulated pneumatic actuator. A signal generating/receiving device is in communication with the transducers and provides the ability for analyzing the test results to determine whether the filter has an internal flaw, such as a crack or void that would render it unsatisfactory for use as a particulate filter.

### TECHNICAL FIELD

The present disclosure relates generally to detecting internal flaws, such as cracks, in particulate filters, and more particularly to an apparatus and method for non-destructive evaluation of particulate filters using ultrasonic techniques.

### BACKGROUND

Increasingly stringent governmental regulations are reducing the permitted levels of undesirable emissions from internal combustion engines. Among these regulated emissions is particulate matter. In the case of diesel engines, many engine manufacturers are choosing to reduce particulate matter emissions through the use of particle traps. These particle traps typically take on a cylindrical shape with a honeycomb structure cross section. Generally, these honeycomb structures are formed by bringing a powder of ceramic, metal or the like together with a binder, and extruding the mixture with a honeycomb shape. This structure is then fired to fix the honeycomb shape. In some instances, these filters may then be coated with a suitable catalyst to facilitate exhaust aftertreatment of other constituents, such as by the inclusion of a diesel oxidation catalyst for oxidizing hydrocarbons and carbon monoxide to carbon dioxide gas and other more desirable compounds. It is well known that, during the production process, occasional internal defects, such as cracks and internal voids, can sometimes occur in the honeycomb structures. When a crack occurs in cell walls of the honeycomb structure, the crack can result in a substantial deterioration in the ability of the filter to trap particles according expectations and specifications. Visual inspections have proven an inadequate strategy for detecting internal flaws in particulate filters.

It is known to employ an ultrasonic testing strategy to detect internal flaws in honeycomb structures. In one such strategy, a person holds an ultrasound transducer in each hand and presses them against opposite sides of the honeycomb structure. An ultrasonic through transmission test in a volume fraction of the filter is then performed. This test consists of generating an ultrasound signal in one of the transducers, transmitting the signal through the filter and receiving a resultant signal in the transducer on the opposite side. If the ultrasound signal is shown to be substantially attenuated at the opposite side, this could be an indication of an internal crack or void, based on the assumption that the ultrasound can not bridge the gap represented by the crack or void. The person may perform this ultrasound through transmission test technique at several different locations through the particulate filter. While this ultrasound strategy can be useful in identifying some, and maybe a majority, of particulate filters with internal flaws, some flaws can go undetected or overlooked, and the filter can be misdiagnosed, due to many potential sources. Among these sources are inconsistent application of force, misalignment of the two transducers, defects in the transducer apparatus, changes that occur due to temperature, humidity and other factors, inconsistencies between filter structures due to wall thicknesses and plug lengths, and other variables known to those skilled in the art.

In another strategy for detecting cracks, U.S. Pat. No. 6,840,083 to Hijikata teaches a potentially destructive method for detecting an internal flaw. In this strategy, the particle trap is positioned in an upright orientation on top of a platform. An impact load is applied to the top of the trap. The particle trap is then moved, and any powdery substance that has dropped from the particle trap onto the platform is then analyzed to determine the location and magnitude of any internal flaws within the particle trap. Although this strategy may possibly be useful in detecting some internal flaws, it presents the risk of exacerbating and/or creating new cracks.

The present disclosure is directed to overcoming one or more of the problems set forth above.

### SUMMARY OF THE DISCLOSURE

In one aspect, a method of detecting an internal flaw in a particulate filter includes a step of positioning a filter in a test apparatus. An ultrasound pulse-echo test is performed from one side of the filter. At least one of a second ultrasound pulse echo test from a second side of the filter, and an ultrasound through transmission test through the filter is performed. Then, it is determined whether one of the ultrasound tests indicate an internal flaw within the filter.

In another aspect, a filter internal flaw test apparatus includes a frame with a filter support and a pair of transducer supports. A pair of transducers are positioned on the transducer supports in alignment with one another and adjacent opposite ends of the filter support. A force generator is connected to the frame and is operable to push the pair of transducers toward each other with a predetermined force. A signal generating/receiving device is in communication with the pair of transducers.

### BRIEF DESCRIPTION OF THE DRAWINGS

FIG. 1a is a schematic front view of a filter and test apparatus according to one aspect of the present disclosure;

FIG. 1b is a side schematic view of the filter and test apparatus of FIG. 1a;

FIG. 2a is a front schematic front view similar to that of FIG. 1a, with an enhancement in the form of computer processing;

FIG. 2b is a side schematic view of the filter and test apparatus of FIG. 2a;

FIG. 3 is a front schematic view of a filter and test apparatus similar to FIGS. 2 and 3, with the addition of actuators for reconfiguring the relative position of the filter in the test apparatus;

FIG. 3b is a side schematic view of the filter and test apparatus of FIG. 3a;

FIG. 4a is a front schematic view of a filter and test apparatus similar to FIG. 3 with the addition of enhanced computer control and processing features;

FIG. 4b is a side schematic view of the filter and test apparatus of FIG. 4a;

FIG. 5a is a front schematic view of a filter and test apparatus similar to that of FIG. 4, with the addition of a plurality of transducers in a transducer array;

FIG. 5b is a side schematic view of the filter and test apparatus of FIG. 5a;

FIG. 6a is a front schematic view of a filter and test apparatus similar to that of FIG. 5, with alternative data acquisition features;

FIG. 6b is a side schematic view of the filter and test apparatus of FIG. 6a;

FIGS. 7a, b and c are illustrations of an uncracked filter, a graphical illustration of ultrasound through transmission test data, and a graphical illustration of ultrasound pulse echo test data, respectively;

FIGS. 8a, b, c are similar to FIG. 7a-c except the filter includes a crack that extends part way through the test volume fraction;

FIGS. 9a, b and c are similar to FIGS. 7a-c except the crack extends completely across the test volume fraction of the filter;

FIGS. 10a, b and c are similar to FIGS. 9a-c except the crack is large and open extending across to the test volume fraction of the filter;

FIGS. 11a, b, c are similar to FIGS. 9a-c except the crack location is close to one side of the filter;

FIGS. 12a, b and c are similar to FIGS. 11a-c except the crack in the filter is at about a one third depth;

FIGS. 13a, b and c are similar to FIGS. 11a-c except the crack is about at a half depth into the filter; and

FIGS. 14a, b and c are similar to FIGS. 11a-c except the crack is located near the right hand side of the filter.

### DETAILED DESCRIPTION

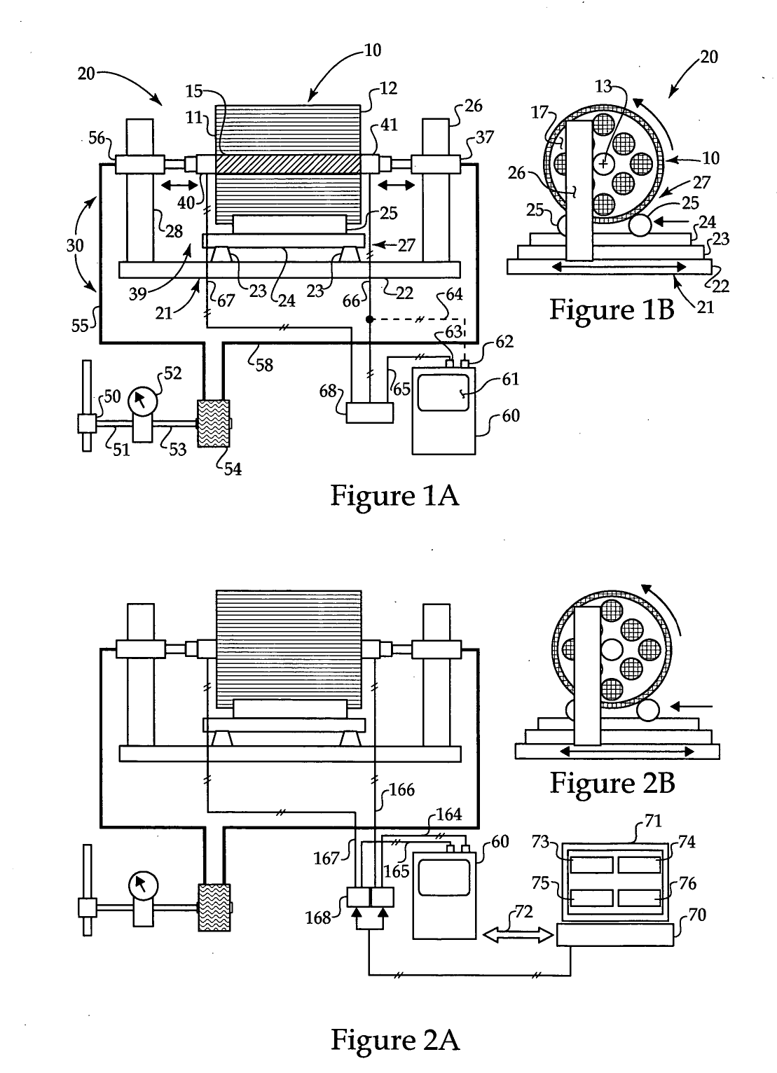

Referring initially to FIGS. 1a and 1b, a filter 10 and a test apparatus 20 are schematically shown with regard to one embodiment of the present disclosure that involves substantial manual involvement for filter evaluation. Particulate filter 10 includes a first side 11, a second side 12 and a centerline 13 extending between the sides. Particulate filter 10 is shown with a template 17 attached to second side 12 as a means of guiding an operator of test apparatus 20 in conducting a plurality of ultrasound tests through different volume fractions 15 of the filter corresponding to the respective holes in the template. The test apparatus 20 has a frame 21 that includes a filter support 27 in the form of a roller mechanism 25, and a pair of transducer supports 26 and 28. A pair of ultrasonic transducers 40 and 41 are positioned on the transducer supports 28 and 26, respectively, and are adjacent opposite ends of the filter support roller mechanism 25. A force generator 30, which in the illustrated embodiment includes a pair of air cylinders 56 and 57 connected to frame 21. Air cylinders 56 and 57 are operable to push the pair of transducers 40 and 41 toward each other with a predetermined force by being supplied with a uniform air pressure. The transducers 40 and 41 may communicate with a signal generating/receiving device 60 via appropriate communication cables 64, 65, 66 and 67.

In more particularly, test apparatus 20 includes a frame 21 that includes a base 22 upon which a pair of rails 23 are mounted. A platform 24 is moveably connected to rails 23 such that the platform, and the roller mechanism 25 that it supports, can be moved to the left and right, as shown in FIG. 1b, with regard to the transducer supports 26 and 28. By locating the transducers 40 and 41 at about the same level as centerline 13 of particulate filter 10, the movement of platform 24 can be adjusted to test any location across the diameter of particulate filter 10. A separate movement resistance feature (not shown) allows platform 24 to be stopped and held and any desired location to the left and right as shown in FIG. 1b. Thus, the combination of movable platform 24 and roller mechanism 25 mounted on rails 23 can be thought of as a reconfiguring device 35 that is operable to reconfigure the relative position of the particulate filter with respect to the pair transducers. Roller mechanism 25 is operable to reconfigure the relative position of the particulate filter 10 with regard to the pair of transducers 40 and 41. This can be accomplished simply by rotating particulate filter 10 about its centerline 13 on roller mechanism 25. Thus, by using the reconfiguring device 35 of test apparatus 20, and by positioning the transducers 40 and 41 at about the height of the particulate filter centerline 13, any location across the sides 11 and 12 of the filter can be accessed by the transducers. In the illustrated embodiment, an operator would utilize the reconfiguring device 35 to test a plurality of volume fractions 15 of particulate filter 10 corresponding to the hole pattern provided by template 17 as shown in FIG. 1b. The test locations represented by template 17 are equidistant from adjacent test locations.

The force generator 30 of test apparatus 20 is illustrated as including a pair of air cylinders 56 and 57 that have the pair of transducers 40 and 41 mounted on couplers 45 and 46, respectively. Although not necessary, a bias, such as a spring, (not shown) may be included in air cylinders 56 and 57 to bias them away from the respective sides 11 and 12 of particulate filter 10 so that the transducers 40 and 41 are normally out of contact with particulate filter 10 when air pressure is low in the air cylinders 56 and 57. In the illustrated embodiment, air cylinder 56 is connected to a manual valve 54 via a pressure supply line 55, and air cylinder 57 is connected to manual valve 54 via a second pressure supply line 58. Manual valve 54 is illustrated as being manually operated via a foot pedal that is available to the operator of the test apparatus 20, but could be any other suitable valve that is directly or indirectly controlled by some manual hand foot or other action on the part of the operator of test apparatus 20. Manual valve 54 may also include some biasing means to bias its position to normally keep pressure supply lines 55 and 58 closed to regulated pressure supply line 53. Thus, this would allow air cylinders 56 and 57 to only be pressurized when the foot pedal of manual valve 54 was depressed. Regulated pressure supply line 53 is connected to a pressure source 50 via a high pressure line 51 and a pressure regulator 52. By appropriately adjusting pressure regulator 52, a uniform pressure can be made in pressure supply line 53, and hence supply lines 55 and 58 when valve 54 is actuated. By utilizing a uniform pressure, a uniform and predetermined force can be generated to push the transducers toward one another in contact with respective sides 11 and 12 of particulate filter 10. Although this embodiment is illustrated via the use of air cylinders, those skilled in the art will appreciate that a wide variety of other actuators could be substituted without departing from the spirit and scope of the present disclosure. Among the potential substitutions are hydraulic cylinders, electric motors coupled to an appropriate worm gear or rack and pinion device, solenoids, or any other known actuator that can be used to push the transducers 40 and 41 into contact with the respective side of particulate filter 10 with some predetermined and suitable force that allows for good transmission of ultrasound into the filter while avoiding potential detrimental effects associated with using too much force.

The signal generating/receiving device 60 preferably includes a display 61 that can display a time trace of ultrasound magnitude that is received by one or the other of transducers 40 and 41. By utilizing a manual switch 68 and the various communication cables 64-67 with appropriate connectors (not shown), various different connections can be made to first and second ports 62 and 63 of signal generating/receiving device 60 to perform an ultrasound through transmission test from transducer 40 to 41, or vice versa, an ultrasound pulse echo test from transducer 40, and an ultrasound pulse echo test associated with transducer 41. For a pulse-echo test, signal generating/receiving device 60 sends and receives a signal through port 63. Thus, switch 68 can be used to connect transducer 40 to port 63 through cables 67 and 65 to perform a pulse-echo test on the first side 11 of the filter, or connect transducer 41 to port 63 through cables 66 and 63 to perform a pulse-echo test on the second side 12 of the filter. For a through-transmission test signal generating/receiving device 60 can also be thought of as including an ultrasound transmission feature originating from one of first and second ports 62 and 63. The other port is associated with an ultrasound receiving port that provides information for display of a received ultrasound signal verses time on display 61. For instance, if an ultrasound through transmission test were to be conducted using transducer 40 as the transmitter and transducer 41 as the receiver, port 63 might be connected to transducer 40 via communication cable 65, switch 68 and communication cable 67. Transducer 41 would be connected to port 62 on signal generating/receiving device 60 via communication cable 66 and communication 64, which is shown as a dotted line to reflect the likely need to make various disconnections and reconnections in order to perform all of the different ultrasound tests on one volume fraction 15 of particulate filter 10. This embodiment of the present disclosure relies upon the operator to interpret the ultrasound magnitude data presented on display 61 in making a decision as to whether a crack exists in the specific volume fraction 15 of particulate filter 10 being tested with one of the ultrasound through transmission or pulse echo test available with appropriate connections. Note that it is assumed here that signal generating/receiving device 60 cannot operate both ports 62 and 63 in pulse-echo mode independently. However, if the signal generating/receiving device has an independent capability, then manual and/or electronic cable reconnection may not be needed.

Referring now to FIGS. 2a and 2b, a more sophisticated version of the disclosure includes a computer controlled electronic switch 180 that is in communication with a computer 70 via a control communication line 169. Computer 70 also communicates with, and may receive data from, signal generating/receiving device 60 via a communication means, such as a cable, 72. By utilizing the electronic switch 168, test apparatus 120 can accomplish all of the through transmission and pulse echo tests by reconfiguring the switch rather than by changing the connections to ports 62 and 63 of signal generating/receiving device 60. Also, the computer connection 72 also allows for potential computer decision making via a flaw detection algorithm with regard to the results of each of the ultrasound tests which may be displayed on a conventional computer monitor display 71. Thus, test apparatus 120 of FIGS. 2a and 2b provides some enhanced capabilities through the use of a computer 70 over that possible with the manual test apparatus 20 of FIGS. 1a and 1b. In the illustrated embodiment, the pulse echo test result from transducer 40 is displayed at location 73 on monitor 71, the pulse echo test from transducer 41 is displayed at location 74, the ultrasound through transmission test is displayed at location 75, and the overall pass/fail of the particulate filter 10, or at least one volume fraction, is displayed at location 76. Not only does the computer allow for automated decision making with regard to a pass or fail with each of the respective ultrasound tests, but it can also hasten the testing procedure by using appropriate programming to command the positioning of electronic switch 168, the transmission and receiving action of signaling generating/receiving device 60 to cycle sequentially through the through transmission and pulse echo tests in a quick manner. Thus computer 70 includes a flaw detection algorithm that analyzes signals from signal generating/receiving device 60 and makes a determination as to whether a flaw has been revealed by that respective through transmission or pulse echo test.

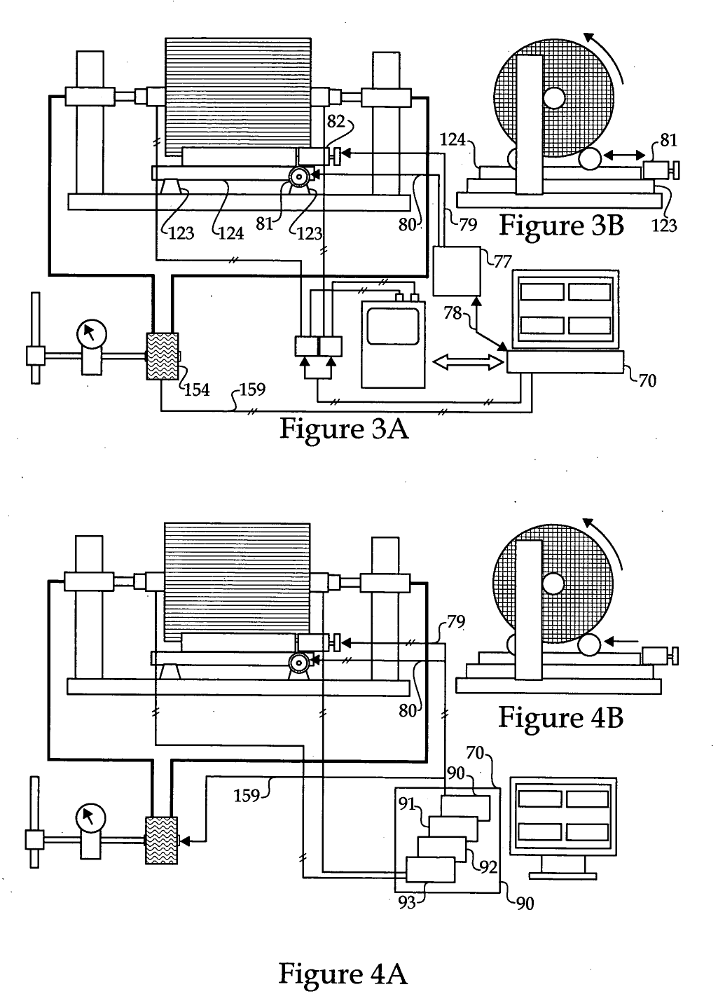

Referring now to FIGS. 3a and 3b, a further enhanced test apparatus 220 utilizes computer 70 not only to control signal generating/receiving device 60 and electronic switch 168, but also to control an electronic valve 154 and the reconfiguration device discussed earlier via actuators 81 and 82. In this embodiment, computer 70 would be in communication control with a configuration controller 77 via a communication line 78. Configuration controller 77 would provide appropriate control signals to actuators 81 and 82 via respective communication lines 80 and 79. Thus, in this embodiment, the computer 70 of test apparatus 220 would and also include a reconfiguration control algorithm that might reflect an electronic version of the template 17 shown in FIG. 1, along with a desired sequence for control of movements to cycle and reconfigure the filter with respect to the test apparatus 220 to test each location reflected by the template 17 of FIG. 1b. Thus, the predetermined pattern reflected by template 17 and the sequence by which the various locations dictated by the template were tested could be programmed in an appropriate reconfiguration control algorithm stored and run on computer 70. Actuator 81 might be an appropriate stepper motor that interconnects platform 124 to rails 123 and allows movement of platform 124 to the left and right as shown in FIG. 3b depending upon control signals supplied to the actuator. In addition, actuator 82 might also be a stepper motor that controls rotation of roller mechanism 125 to change the angular orientation of particulate filter 10 in test apparatus 220 to any desired angle, such as to align the transducers with a different one of the test locations indicated by the template 17 shown in FIG. 1b, which is stored electronically in this embodiment.

Referring to FIGS. 4a and 4b, a different computer 270 may be substituted in the place of computer 70 of the FIG. 3a embodiment and include dedicated internal cards for each of the different control, data processing and data acquisition functions. These internal cards should allow for a higher speed in evaluating each individual filter with a faster flow detection algorithm. Computer 270 might also include a capability to load different inspection parameters so that the apparatus, among other things, can accommodate different sized and/or shaped filters. This embodiment also differs from the embodiment of FIG. 3 in that the signal receiving device of FIG. 3 has been eliminated and its transmission and receiving features have been incorporated into computer 270 by equipping computer 270 with an appropriate pulser/receiver (P/R) data acquisition card 92 and electronic switch control card 93 along with appropriate connections that allow transducers 40 and 41 to be connected directly to computer 270 via respective cables 261 and 262. Even though typically not necessary, computer 270 may also include a dedicated data processing card 91 that should also hasten the decision making process involved in evaluating an individual filter.

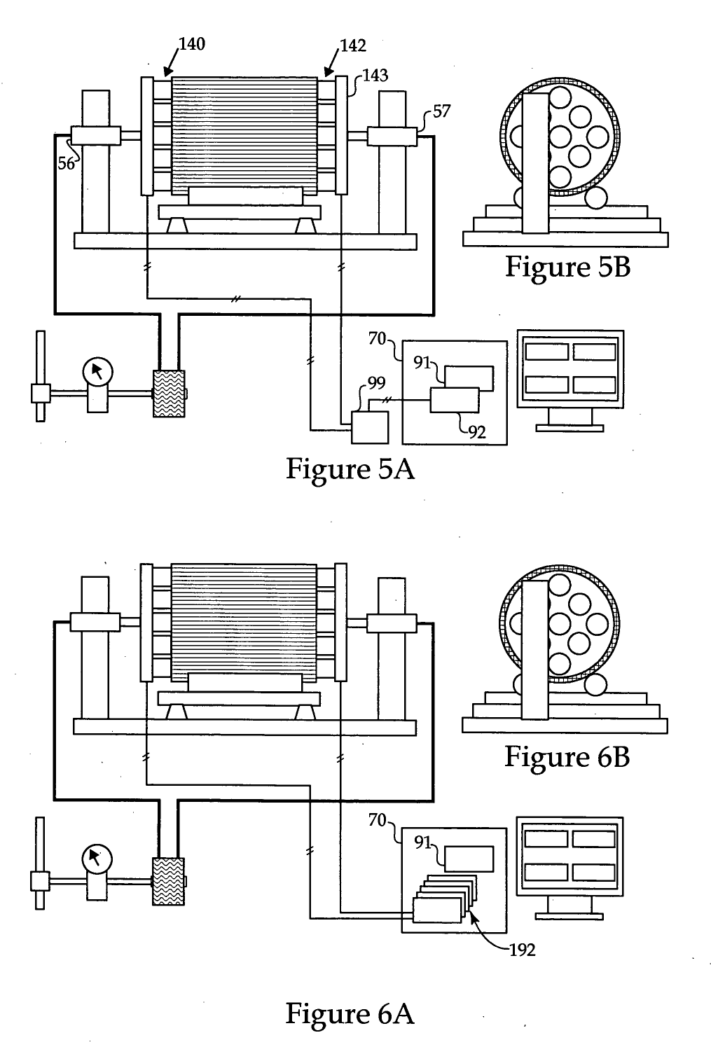

Referring now to FIGS. 5a and 5b, still another enhanced embodiment of a test apparatus 420 includes first and second transducer arrays 140 and 142 that each include a plurality of transducers similar to that illustrated with the earlier embodiments. In this case, each of the transducers of transducer array 140 are attached to a panel 144 that is moved to the left and right via a dedicated air cylinder 56, and the second transducer array 142 includes a plurality of transducers connected to a panel 143 that is moved to the left and right by air cylinder 57. By utilizing a transducer array, it becomes possible to conduct ultrasound tests on a plurality of different volume fractions of particulate filter 10 simultaneously, or at least in quicker succession since little to no reconfiguration of the filter 10 with regard to the test apparatus 420 may need to be done depending upon the number and distribution of transducers in each respective transducer array 140 and 142. Transducer array 140 is connected to a multi channel electronic switch 99 via a cable 361, and transducer array 142 is also connected to multi channel electronic switches 99 via a cable 362. The multi channel electronic switches 99 are controlled via a dedicated pulser/receiver data acquisition card 292 via a communication line 98. The ultrasound data received from transducer arrays 140 and 142 would then be processed via computer or a dedicated data processing card 291. Thus, by using appropriate programming and the multi channel electronic appropriate programming on the cards 291 and 292 of computer 270 along with the multi channel electronic switches 99 and the transducer arrays 140 and 142, a complete evaluation of a given filter 10 can be accomplished even faster with the test apparatus 420 over that probable with regard to the enhanced test apparatus 320 shown in regard to FIGS. 4a and 4b.

Referring now to FIGS. 6a and 6b, still another enhanced test apparatus 520 is shown in which computer 270 includes a dedicated P/R data acquisition card 192 associated with each of the transducer pairs in transducer arrays 140 and 142 to further hasten the evaluation process of each individual filter. Those skilled in the art will appreciate that even further enhancements of a test apparatus are possible, such as including an automated filter loading and unloading feature into the test apparatus. Thus, the test apparatus 520 still requires an operator to load and unload particulate filters in the test apparatus, but all the other processes including generating and receiving signals and processing and decision making are all automated and performed by computer 270. For instance, a fully automated production inspection machine might have a horizontal configuration in which filters are positioned sequentially on a moving production line that brings filters one at a time to an inspection station that would include much of the features similar to those of the test apparatuses previously described. Although the previously described test apparatuses show the filters as having a horizontal orientation in the test apparatus, those skilled in the art will appreciate that with minor modifications the filters could be inspected while being oriented in a vertical manner. Further, because of the often cylindrical shaped filters, a vertical testing strategy may be more desirable if the inspection machine were fully automated. For instance, a production line could have a plurality of filters positioned on a movable conveyor that had an opening adjacent the filter face so that the test apparatus transducers could contact that face as each sequential filter arrived at the inspection station. The vertical orientation strategy might also include some turn table support apparatus for rotating a filter at the testing station. Thus, those skilled in the art will appreciate that any number of enhancement could be made to automate, increase data processing speed and accuracy and other considerations known in the art without departing from the present disclosure.

### INDUSTRIAL APPLICABILITY

Referring now to FIGS. 1a-6b, the evaluation procedure for any of the test apparatuses 20-520 is initiated by an operator loading a particulate filter 10 into the respective test apparatus. In the case of the versions of FIGS. 1a-2b, the operator may also attach an appropriate template 17 to one side of the particulate filter for use in guiding the operator to test a plurality of different volume fractions 15. Next, the operator may depress the pedal 54 to push the transducers 40 and 41 against the respective sides of the sides 11 and 12 of particulate filter 10. In the case of the embodiment in FIGS. 1a and 1b, the operator would need to make the appropriate connections to signal generating/receiving device 60 to conduct each of the different ultrasound through transmission and pulse echo tests. In particular, the present disclosure preferably has an ultrasound through transmission test and both a left and right pulse echo tests performed for each volume fraction 15. It has been found that a through transmission test can miss some cracks that would be detected by the pulse echo test. On the other hand, the pulse echo test typically will miss cracks located close to the respective transducer. Thus, the different tests compliment one another and provide a reliable way of evaluating each volume fraction for most cracks located between the sides 111 and 12 of the particular filter for a given volume fraction 15. Thus, in the embodiment of FIG. 1a and 1b, the operator might have to connect and reconnect different cables 64-67 and/or manipulate switch 68 to conduct each of the different through transmission and pulse echo tests on each volume fraction 15.

After each volume fraction 15 is tested, the operator would examine the results displayed on display 61 and make a decision if a crack existed and if the filter should pass/fail. If a crack is revealed at any stage in the operation, the operator may simply mark that particular particle trap as defective, remove it from the test apparatus and proceed to begin testing another particulate filter or choose to continue to finish all other locations. If the tests for a given volume fraction 15 reveal no internal defects, the operator may release pedal 54 and allow the transducers 40 and 41 to move away from the sides 10 and 12 of the particulate filter 10. The operator would then reconfigure the device to align the transducers 40 and 41 with another one of the openings in template 17. The operator would then depress pedal 54, apply pressure to move the transducers 40 and 41 back into contact with particulate filter 10, and then cycle through each of the through transmission and pulse echo tests reading the results of each individual test on display 61 and making a decision therefrom.

Those skilled in the art will appreciate that some of the various features described with regard to FIGS. 1a and 1b are either automated or hastened in the enhanced test apparatuses 120-520 illustrated in FIGS. 2a-6b. For instance, manual decision making can be supplemented by computer decision making in the FIG. 2 embodiment, and also the need to possibly connect and reconnect different cables to perform all the tests could be eliminated in the FIG. 2a-2b embodiment. The embodiment of FIG. 3 could allow for automated reconfiguring of the filter in the test apparatus 220 rather than manually as in the previous embodiments to further hasten the evaluation procedure. The embodiment of FIG. 4 further hastens the evaluation procedure by having dedicated internal cards in the computer for more quickly gathering and analyzing data from the various ultrasound through transmission and pulse echo tests to be conducted. The embodiment of FIGS. 5a and 5b can further reduce time by conducting a plurality of tests nearly simultaneously without the need to reconfigure the filter for each different volume fraction to be tested. Nevertheless, some reconfiguring of the filter in the test apparatus 420 of FIGS. 5a and 5b may be necessary if the transducer arrays do not cover the complete area to be tested. Finally, the test apparatus 520 of FIGS. 6a and 6b can further hasten the gathering of data from the transducer arrays through the use of dedicated pulse/receiving data acquisition cards 192, over that of the FIGS. 5a, 5b embodiment.

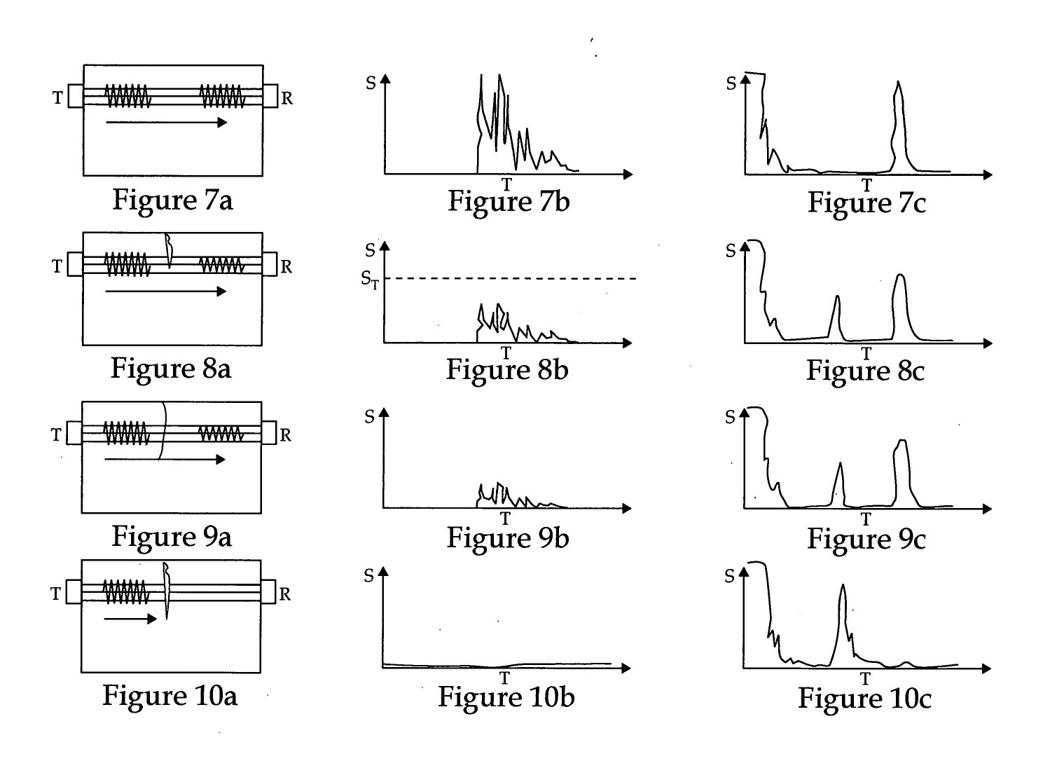

Referring now to FIGS. 7a-10c, example tests are illustrated to better show what type of signal data could be expected for various filters with or without internal flaws. In FIGS. 7a-7c, an example good filter without internal flaws is shown being testing at one volume fraction 15. FIG. 7b shows that when the ultrasound transmitted from transducer 40 is received with a relatively strong signal at receiving transducer 41, this reveals no crack between the transducers. FIG. 7c shows a pulse echo test data wherein the transducer 40 both transmits and receives an ultrasound signal. It shows that a relatively strong front and back signals F and B are received showing that there were no internal cracks that could scatter or reflect the ultrasound signal. If a similar pulse echo test were performed from transducer 41, a graph similar to that shown in FIG. 7c would result. Thus, any signals differing substantially from those of FIGS. 7b and 7c could be indicative of an internal flaw in a given filter 10.

Referring now to FIG. 8a, the filter 10 includes a crack C that extends part way across the volume fraction 15b tested. FIG. 8b shows that when the ultrasound through transmission test is performed, a weak signal is received at the receiving transducer since the crack C attenuates or blocks much of the ultrasound from getting through to the receiving transducer. Thus, an operator examining a graph of FIG. 8b would conclude that a crack of some magnitude existed between the transducers. In the case of automating that decision making, the computer may include some threshold S_{T} signal strength that if the receiving signal does not exceed that threshold, the computer would decide that a crack existed and that the respective particulate filter was defective. Comparing the received signal to threshold signal S_{T} would be part of a flaw detection algorithm according to the disclosure. The processing of the received signal may all be part of the flaw detection algorithm. The graph of FIG. 8c shows that a weak reflected signal created between the front and back surface signals and indicates a crack about half way into the particulate filter. Those skilled in the art will appreciate that the magnitude of that reflected signal that reflects off of crack C will be indicative of either how far the crack extends across the volume fraction being tested and/or whether the crack is open or still somewhat together, thus allowing some of the ultrasound to pass from one side of the crack to the other without revealing its presence.

Referring now to FIG. 9a, a large and relatively closed crack still reveals itself with a relatively weak signal in the transmission through test data illustrated in FIG. 9b since even a relatively closed crack will substantially attenuate the ultrasound signal preventing the same from passing through to the receiving transducer but part of the ultrasound may pass through the closed part of the crack. The graph of FIG. 9c is similar to that of FIG. 8c in that the crack produces a surface that reflects the ultrasound signal back and reveals a crack at about the half way depth between the front and back reflected signals F and B (FIG. 7c). Part of the flaw detection algorithm may be to identify F and B, confirm that they are the right distance apart, then scan for reflected signals between F and B that could indicate a crack. Thus, by locating the front and back reflected signals in the pulse echo test as well as where any reflected signals is located between the front and back, one can ascertain the relative depth of the flaw in the filter. This type of information may not be possible to obtain with a transmission through test. Thus, the pulse echo test can provide very reliable information for a bulk of the middle section of the filter, but because of reflection off the front and back surface, it has difficulty in revealing flaws that are close to either side of the filter.

FIGS. 10a-10c show expected signals when a crack V is large and open. In the case of the through transmission test, no signal is able to cross severe crack V and thus, indicates a relatively substantial internal flaw in the filter 10. On the other hand, the pulse echo test data as shown in FIG. 10c confirms the existence of a relatively substantial open crack V by returning a relatively large signal and no back reflection as shown in FIG. 10c. A series of echoes may be seen because of multiple reflections between the filter surface and crack V.

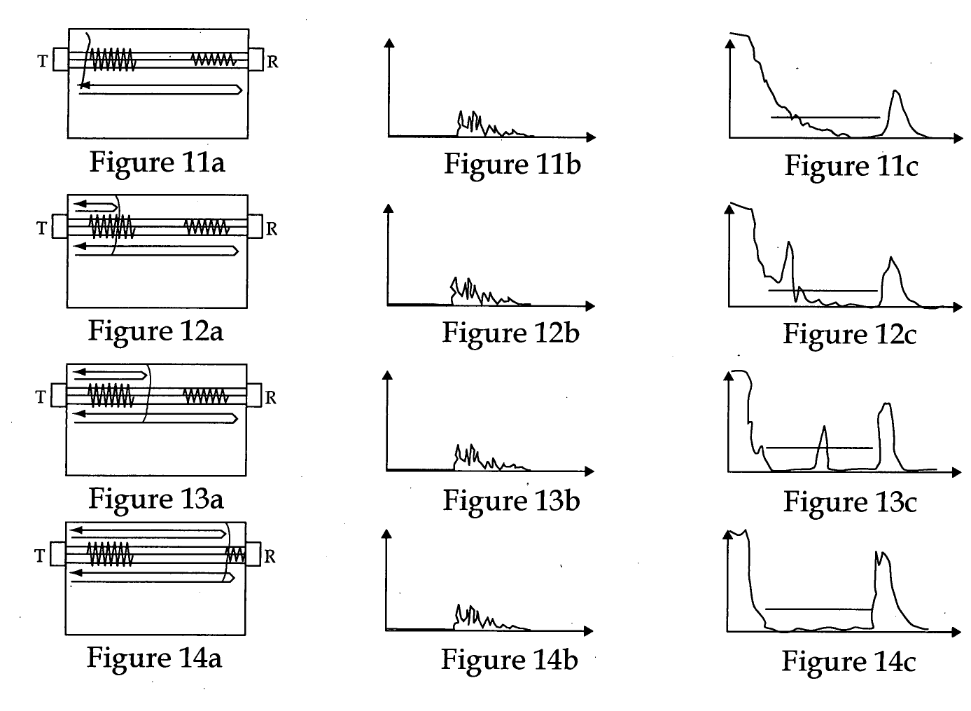

Referring now the illustrations and graphs of FIGS. 11a-14c, the ability of the ultrasound through transmission and pulse echo tests to compliment one another are illustrated. For instance, when a crack is relatively close to one of the side surfaces, such as that shown in FIGS. 11a and 14a, the pulse echo tests have difficulty seeing this data as the reflection from the crack is embedded in the reflection from the respective front or back surface making a crack difficult to detect. However, the ultrasound through transmission test data shown in FIGS. 11b and 14b show that the through test is useful in detecting cracks close to one side or the other of the filter. FIGS. 12a-13c are useful in illustrating that the ultrasound through transmission test is not sensitive to depth of where a crack might be located, whereas the pulse echo test can provide useful information as to the depth into the filter of where a crack is likely located. Thus, the pulse echo tests can be thought of as having blind zones adjacent the front and back surfaces of the filter, but they do provide additional data regarding depth of a flaw if one occurs farther away from these outer surfaces of the filter. On the otherhand, the through transmission tests provide little information as to crack depth, but can cover the blind zones of the pulse echo tests so that cracks near the surface of the filter do not go undetected.

Those skilled in the art will appreciate that the ultrasound signals received in manufacturing particulate filters typically have a lot of variations due to variations in filters, such as filter length, plug length, cell wall thickness, material density, possible catalyst and moisture, and variations in ultrasonic measurements, such as coupling conditions and applied pressures. It is therefore typically difficult to set a threshold for a through-mode test without calibration. This test mode can typically reliably detect severe large and open cracks which give a dead or near zero signal, but is not as able to reliably detect partial cracks or closed cracks as reliable. The through transmission method, however, is capable of detecting severe cracks close to the plugs. The pulse echo mode, on the other hand, can reliably detect severe cracks as well as closed, partial, small cracks. But the pulse echo test has difficulty in identifying cracks in the blind zones near the front and back sides of the filter. In the test configuration presented in this disclosure, one can conveniently perform a pulse echo test from the first side of the filter and perform another pulse echo test in the same volume fraction from the other side of the filter. The second test can confirm cracks found in the first test. The second test can also help to determine some cracks in the blind zones of the first test, because the width of the front surface and the back surface blind zones are typically different, in that the blind zones of the first and second tests are switched. For large sized filters, the two pulse echo tests can effectively cover the entire filter length. One can also conveniently perform a through transmission test using the same configuration to confirm cracks and to detect severe cracks that are very close to filter surfaces. Even though it is typically desirable to incorporate through-transmission test to maximize probability of detection, one may choose to omit the through-transmission test in certain situations to simply the testing. Those skilled in the art will also appreciate that enhanced versions of the disclosure could utilize and exploit signal processing techniques to dampen noise and possibly filter out some of the undesirable signal features to better reveal cracks within a filter. For instance, known signal processing techniques such as pattern recognition could be used to help make pass/fail judgments for cracks in the blind zones associated with the pulse echo tests. Those skilled in the art will appreciate that using a distance amplitude correction in the pulse echo mode might permit ultrasound to have the same sensitivity to cracks at different depths.

Because there are a lot of variations in the signal, it may be best to perform some calibrations to make sure the inspection system is in control before conducting any tests. In addition, it may be desirable to perform the test in a uniform environment with controlled humidity and temperature, and maintain the filters to be tested in that environment for an adequate time so that they can come to equilibrium with there surroundings so that moisture and temperature do not undermine the tests taking and evaluation procedure. Those skilled in the art will know that for filters used in service and application development programs, the ultrasonic signals are typically further confounded by ash, soot, moisture and temperature. Cautions must be taken in using ultrasonic data to determine if any internal cracks are present in these used filters.

Those skilled in the art will appreciate that the test apparatuses and procedure(s) described above can also be used in evaluating a particle trap manufacturing process. In other words, a raw uncanned trap may be received from a manufacturer and then go through a variety of processes to house the trap in an appropriate can and mount the same in an exhaust segment housing for later installation on an engine system. By testing and confirming that given trap is without cracks both before and after the particle trap manufacturing process, the testing can provide a useful tool in confirming that the manufacturing process itself is not causing internal cracks. In addition, by analyzing filters upon receipt from a manufacturer, reduced manufacturing costs can be achieved by avoiding the use of defective filters.

It should be understood that the above description is intended for illustrative purposes only, and is not intended to limit the scope of the present disclosure in any way. Thus, those skilled in the art will appreciate that other aspects, objects, and advantages of the disclosure can be obtained from a study of the drawings, the disclosure and the appended claims.

What is claimed is:

1. A method of detecting an internal flaw in a particulate filter comprising the steps of:
positioning a filter in a test apparatus;
performing a first ultrasound pulse echo test from a first side of the filter;
performing at least one of a second ultrasound pulse echo test from a second side of the filter, and an ultrasound through the transmission test through the filter; and
determining if at least one of tests indicate an internal flaw within the filter.

2. The method of claim 1 including a step of;
performing both the second ultrasound pulse echo test in the filter from a second side, which is opposite the first side and the ultrasound through transmission test; and
the determining step includes a step of determining any of the three tests indicate an internal flaw within the filter.

3. The method of claim 2 wherein the performing steps are performed in a plurality of different volume fractions of the filter in a predetermined pattern.

4. The method of claim 3 including a step of rotating the filter in the test apparatus.

5. The method of claim 3 including a step of re-configuring a transducer pair in the test apparatus to a new position with respect to a centerline of the filter.

6. The method of claim 3 including a step of reconfiguring at least one of the filter and the test apparatus relative to each other with a configuration control algorithm.

7. The method of claim 6 wherein the reconfiguring step includes a step of rotating at least one roller of the test apparatus that supports the filter.

8. The method of claim 1 including a step of holding a transducer against a side of the filter with a predetermined force.

9. The method of claim 8 wherein the holding step includes pushing the transducer against the side with a predetermined fluid pressure.

10. The method of claim 8 including a step of controlling application and removal of the predetermined force with a foot pedal.

11. The method of claim 1 including a step of holding at least two pairs of transducers against opposite sides of the filter; and
performing an ultrasound through transmission test and a pair of ultrasound pulse echo tests from opposite sides of the filter with each pair of transducers.

12. The method of claim 11 including a step of arranging the transducer pairs according to a template that locates adjacent transducer pairs equidistant from one another.

13. The method of claim 1 including a step of displaying ultrasound signal data from the ultrasound through transmission test and the ultrasound pulse echo test.

14. The method of claim 1 including a step of evaluating ultrasound through test data and ultrasound echo test data with a flaw detection algorithm; and
indicating whether the flaw detection algorithm detected a flaw.

15. A filter internal flow test apparatus comprising:
a frame that includes a filter support and a pair of transducer supports;
a pair of transducers positioned on the transducer supports in alignment with one another and being adjacent opposite ends of the filter support;
a force generator connected to the frame and being operable to push the pair of transducers toward each other with a predetermined force; and
a signal generating and receiving device in communication with the pair of transducers.

16. The filter test apparatus of claim 15 wherein the filter support includes a roller mechanism.

17. The filter test apparatus of claim 15 wherein the force generator includes a source of pressurized fluid and a pressure regulator.

18. The filter test apparatus of claim 15 wherein the signal receiving device includes a computer with a flaw detection algorithm.

19. The filter test apparatus of claim 15 including at least one reconfiguring device operable to reconfigure the position of at least one of the filter and the pair of transducers relative to each other.

20. The filter test apparatus of claim 19 including a computer with a configuration control algorithm, and the computer being in communication with the at least one reconfiguring device.
